(19) United States
(12) Patent Application Publication
(10) Pub. No.: US 2007/0100525 A1
(43) Pub. Date: May 3, 2007

(54) Safety apparatus for a motor vehicle, and method for communicating the status of a safety apparatus of a motor vehicle

(76) Inventors: Bernhard Mattes, Sachsenheim (DE); Hans-Peter Stumpp, Markgroeningen (DE); Werner Nitschke, Ditzingen (DE); Hartmut Schumacher, Freiberg (DE); Walter Wottreng, Gumna-Ken (DE); Hans Guettler, Untergruppenbach (DE); Rainer Moritz, Filderstadt (DE); Thomas Herrmann, Oehringen (DE); Frank-Juergen Stuetzler, Farmington Hills, MI (US); Knut Balzer, Beilstein (DE); Thomas Lich, Schwaikheim (DE); Ulrike Groeger, Stuttgart (DE); Alfred Kuttenberger, Moeglingen (DE); Lothar Groesch, Farmington Hills, MI (US); Michael Schmid, Kornwestheim (DE); Mario Kroeninger, Buehl (DE)

Correspondence Address: KENYON & KENYON LLP, ONE BROADWAY, NEW YORK, NY, 10004, US

(21) Appl. No.: 10/558,806

(22) PCT Filed: Mar. 25, 2004
(86) PCT No.: PCT/DE04/00613

§ 371 Date: Dec. 11, 2006

(30) Foreign Application Priority Data
May 28, 2003 (DE) 103 24 215.5

(51) Int. Cl. G05D 1/00; B60R 21/013

(52) U.S. Cl. 701/45; 280/735; 180/271

(57) ABSTRACT

A safety apparatus for a motor vehicle, comprising: a plurality of occupant protection devices and sensors associated with them; a processing device that checks whether the occupant protection devices and/or associated sensors are in operation and/or properly functional, and ascertains status information therefrom; and an output device that, in consideration of all the status information, communicates the operating status possessed by each individual occupant protection device and/or sensor. Also described is a method for communicating the status of a safety apparatus of a motor vehicle.

### FIELD OF THE INVENTION

The present invention concerns a safety apparatus for a motor vehicle and method for communicating the status of a safety apparatus of a motor vehicle.

### BACKGROUND INFORMATION

The introduction of airbags in motor vehicles by Mercedes-Benz in 1980 set in motion extensive development in the field of restraint systems. The results of that development have been not only the passenger airbag but also side airbags, head airbags, knee bags, belt tensioners, and rollover protection devices. With the aid of an additional sensor suite such as an interior or occupant detection sensor suite, or a pre-crash or rollover detection system, a considerable improvement has consequently been achieved in occupant protection in a variety of accident situations. As development in the area of occupant protection proceeds, the number of protective devices is steadily increasing. Conversely, however, at present only one simple indicator exists for the occupant protection systems, indicating the operability of the central airbag control unit and, if applicable, of peripheral sensors.

In the case of one such known indicator, which is usually embodied in the form of an LED or incandescent lamp, the central unit typically checks its operability after the ignition is switched on, i.e. at power-on. At that time the indicator lights up for a predetermined period of time, and goes out if no faults have been detected in the system. A more ambitious approach to visualizing the functionality of the occupant protection system is explained in more detail in a new American bill FMVSS 208. According to this bill, an indicator must be activated as soon as the passenger airbag is switched off, so that the driver and passenger are visually made aware that the corresponding protective device, e.g. the passenger airbag, is deactivated.

A disadvantage of the aforementioned indicators is the undifferentiated information as to operability—i.e. operable/inoperable—as well as limited consideration of the plurality of protective devices present in the vehicle.

### SUMMARY OF THE INVENTION

The safety apparatus according to the present invention for a motor vehicle and the method for communicating the status of the safety apparatus of a motor vehicle have the advantage, as compared with the known approaches to a solution, of making available more comprehensive status information about the safety devices and sensor systems present in the vehicle and, if applicable, about an individual protection level of the occupants resulting, inter alia, therefrom. This additional information is made available before, and in particular also while and/or after driving, and after a possible accident in which the vehicle was involved.

On the one hand, an occupant is thereby made aware of the plurality of safety devices that are present. On the other hand, he is given information as to which protective systems are activated or deactivated or are individually operable or nonfunctional.

What is made available, in other words, is a safety apparatus for a motor vehicle, having: a plurality of occupant protection means and sensors associated with them; a processing device that checks whether the occupant protection means and/or associated sensors are in operation and/or properly functional, and ascertains status information therefrom; and an output device that, in consideration of all the status information, communicates the operating status possessed by each individual occupant protection means and/or sensor.

According to a preferred development, sensors are provided that sense the seating position of at least the driver and/or passenger, and the processing device takes those sensed signals into account in ascertaining the status information. The seating position of an occupant can thus advantageously be included in the occupant protection assessment.

According to a further preferred development, the processing device has a calculation device that, from the status information, calculates an individual occupant safety level at least for the driver and/or passenger and outputs it via the output device. This offers the advantage of an easily understandable presentation of information about individual protection quality as a function of a wide variety of criteria, such as seating position, airbag availability, etc.

According to a further preferred development, the output device has a driver display and/or a separate passenger display and/or a central display having separate indicators for driver and passenger and/or a windshield protection device, respectively for optical communications; and/or a voice output device and/or a warning tone device, respectively for acoustic communications; and/or an electrically displaceable seat and/or a reversible belt tensioner, respectively for haptic communications. In this fashion, predetermined visual signals; or acoustic communications, including in the form of a voice output; or haptic communications, e.g. by tightening of a belt tensioner, can be issued to the occupant(s) of the vehicle. Communications about the occupant protection level can also be conveyed to the occupants in this fashion.

According to a further preferred development, the central data transmission device has a CAN bus. This offers the advantage that all data transferred in the vehicle via a CAN bus, for example ABS- or ESP-relevant data, are conveyed to the transmission apparatus, so that a notification about occupant protection quality based on comprehensive data can be generated and communicated.

According to a further preferred development, the occupant protection system has at least one driver and passenger airbag and a pre-crash sensor device and/or an emergency seat displacement device. A variety of protective devices are thus taken into account by the safety apparatus.

According to a further preferred development, the processing device has an input for GPS data. The resulting advantage is that position data for the vehicle are also known to the communication apparatus, e.g. for placing an emergency call.

According to a further preferred development, the control device has an output for outputting data to the central data transmission device. This offers the advantage that the data generated in the control device are conveyed, for example, to the CAN bus and are thus available to additional systems in the vehicle.

According to a further preferred development, the processing device has a control device having a storage device for storing the status information. It is thus advantageously possible, for example, to draw conclusions from the corresponding data as to a possible accident cause and the exact circumstances of the accident.

According to a further preferred development, signal data relevant to vehicle safety are evaluated in the processing device in such a way that an occupant protection factor for driver and passenger, respectively, is ascertained therefrom, and is communicated to the occupants via the output device before and/or while driving. The advantage of this is a direct report to the occupant, when, for example, as a passenger he extends his legs onto the dashboard and this is sensed by the occupant monitoring device, of the fact that this results in a greatly elevated risk of injury and thus a reduced occupant protection quality.

### BRIEF DESCRIPTION OF THE DRAWING

The FIGURE is a schematic diagram of a communication apparatus, to explain an embodiment of the present invention.

### DETAILED DESCRIPTION

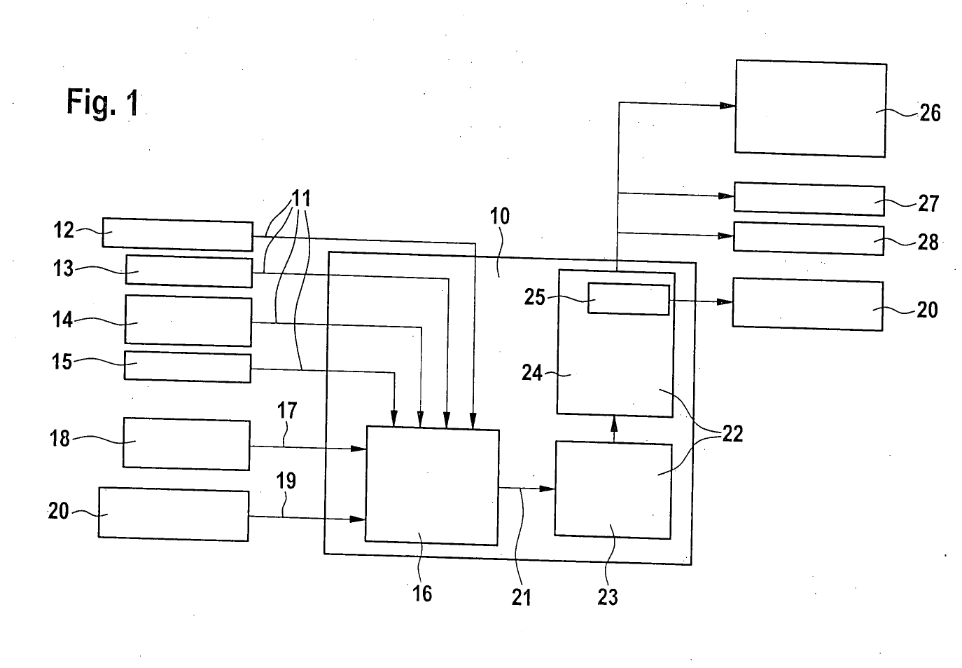

The FIGURE depicts a communication apparatus that reports the current occupant safety quality to occupants of a vehicle, in particular to the driver and passenger. According to FIG. 1, a processing device 10 receives sampled values 11 or status signals from an interior monitoring device 12, an airbag monitoring device 13, a pre-crash monitoring device 14, and a seating position monitoring device 15. Seating position monitoring device 15 provides information about the current seat adjustment of the driver seat and/or passenger seat, in particular including the headrest position. Pre-crash monitoring device 14 furnishes a signal 11 concerning the functionality of the device, as does airbag monitoring device 13. Interior monitoring device 12, on the other hand, provides information e.g. about the manner in which, for example, the passenger is sitting on his seat, and in particular whether the latter has rested his legs on the dashboard. Data 11 received from monitoring devices 12, 13, 14, and 15 are conveyed in processing device 10 to a filtering and/or extraction device 16. According to the exemplifying embodiment in FIG. 1, this filtering and/or extraction device 16 additionally has position data, i.e. GPS data 17, conveyed to it from a GPS device 18.

Data 19 from a central data transmission device 20, for example a CAN bus, are additionally conveyed via an input to filtering and/or extraction device 16. Data 19 from central data transmission device 20 preferably contain ABS or also ESP data. Data 21 processed in filtering and/or extraction device 16 are then conveyed to a control device 22. Control device 22 has a calculation device 23 on which an algorithm can be executed, and a logic device 24 for triggering various output devices 20, 26, 27, and 28. The data generated in processing device 10 are also made available via an interface 25 to central data transmission device 20. A haptically active output device 26, for example a belt tensioner or an electric seating position/headrest adjustment system, is also provided. An acoustic communication is issued, for example, via an acoustic communication device 27 in the form of a voice communication. Reference number 28 designates an optical output device such as a driver display or a separate indicator display for safety status visualization.

Using the algorithm in calculation device 23 of control device 22, the driver's current safety level, for example, can be calculated as follows. If the driver has assumed a normal seating position, the headrest is in the correct position, all safety systems are functional, and the vehicle status (e.g. load or tire pressure) is also OK, the result is then a high occupant protection quality. This can be visualized, for example, by way of a small deflection on a bar indicator. The passenger's safety level, on the other hand, based on a detected seating position with legs supported on the dashboard but otherwise identical criteria, may result in a large deflection of the corresponding bar indicator, since a high risk of injury would exist in the event of an accident.

In other words, an attractive status notification regarding the safety devices and sensor systems is communicated before, while, and after driving and after a possible accident. The communication here encompasses on the one hand presentation in a driver display, as well as colored indicating instruments that are integrated into the cockpit and are within the field of view of both driver and passenger, but preferably are triggered separately from one another. The occupants are thus made aware that a plurality of safety devices are present in the vehicle, for example driver and passenger airbags as well as side and window bags, belt tensioners, etc. In a so-called “pre-drive check,” the driver is informed as to which protective systems or monitoring devices 12, 13, 14, 15 are activated. This is accomplished, for example, by way of a graphical checklist in an indicator display, or also by way of a haptic communication about the functionality of, for example, the belt tensioner by way of a brief tightening of the belt.

In the course of seating positioning monitoring with the aid of a seating position monitoring device 15 and a vehicle interior monitoring device 12, a determination is made, and the driver or passenger is correspondingly informed, as to how his seating position should be optimally selected in order to ensure the best possible restraint system protective effectiveness. In this context, the occupant is preferably informed as to how to adjust his headrest in order to improve occupant protection quality. This is correspondingly monitored, and the occupant is informed by means of a control loop when the preconditions for optimum occupant protection functionality are met.

The occupants additionally obtain a communication as to the current safety both of the vehicle and for themselves while driving. This “dynamic safety check” means that in the context of a correspondingly unsafe seating position, e.g. a passenger with feet supported on the dashboard, a visual and/or acoustic and/or haptic communication is issued. This communication makes the passenger aware that in that seating position, the protection potential of the safety devices is low. The communication can occur, for example, by the fact that a simple indicator changes from green in the context of a normal seating position and yellow to red in the context of a dangerous seating position such as the one described above. As an alternative, a spoken communication can be outputted, or a reversible belt tensioner can be briefly tightened in order, for example, to draw attention to the dangerous seating position. Another advantage of the communication concerning the vehicle safety status is that, for example in extreme driving situations (detected from the ESP data) or extreme external influences such as a strong side wind (also derivable from the ESP data) or a heavy or high load, a warning message can be communicated to the driver. Processing device 10 can moreover, on long drives, communicate to the driver by way of the existing output devices 26, 27, 28, 20 the need for appropriate rest breaks, so that a warning about driver fatigue is also actively given.

In the event an accident occurs, the communication apparatus can inform the driver for reassurance, for example in acoustic fashion, that a rescue service has been notified or that rescue actions have been initiated, if an emergency signal has been transmitted from the vehicle. In addition, all the data of processing device 10 can be stored in a storage device (not depicted) so that, especially in retrospect as well, the current safety levels and seating positions can be understood. This can provide additional details for the accident reconstruction that is necessary in some circumstances.

According to the present invention, processing device 10, for example a control unit, also acquires data 19 from a central data transmission device 20, e.g. a CAN bus. In processing device 10, the relevant variables are extracted and filtered, and processed using an algorithm. As a function of the results of processing device 10, i.e. depending on the situation or phase, the various output media 26, 27, 28, 20 are then addressed. A display already present in the vehicle, for example a cockpit display, and reversible belt tensioners, may preferably be mentioned here.

The present invention also provides for an indicator display that indicates to each occupant his current individual safety status. That status is assembled from not only the seat adjustment and the occupant's seating position or location on the seat, but also other vehicle-dynamics variables such as speed, side wind, float angle, visibility, etc., as well as vehicle-specific variables such as the tire pressure, load, etc. In processing device 10 all the relevant data are collected, filtered, optionally extracted, and processed with a central algorithm, which then triggers the respective communication device 26, 27, 28, 20.

Although the present invention has been described above with reference to a preferred exemplifying embodiment, it is not limited thereto but rather is modifiable in multifarious ways.

For example, not all the possible communication and output devices described are necessary. A purely optical, purely acoustic, or purely haptic communication is also imaginable. Monitoring devices different from those discussed for supplying sampled values are, moreover, also envisioned. In addition, following an accident the output device preferably communicates to an occupant that a rescue service and/or the police have been notified, if an emergency call was placed from the vehicle. The occupants are thereby first of all reassured after an accident, and can also expect prompt rescue if they are in a condition in which they themselves are no longer able to act.

Good options for a “pre-drive check” are a graphic checklist for safety components in a display; confirmation of seatbelt fastening via a brief tightening of the belt tensioner; instructions for optimizing the seat adjustment or steering wheel; preferably a spoken “Occupant protection system activated” communication; and/or a depiction of the static safety level (seat adjustment, headrests, position, loose seatbelt, etc.).

A “dynamic safety check” is based on a representation of the dynamic hazard state, for example by way of the color of the interior illumination, offers the possibility of a warning if, for example, feet are placed on the dashboard; a notification of airbag shutoff when the situation is detected; a warning if the passenger seat is occupied but the passenger airbag is deactivated; a warning of side wind if, while driving straight ahead at high speed, the “float angle” detected by an ESP device increases; a notification of elevated rollover risk with a high vehicle center of gravity caused by a large additional load or roof load; and a notification of recommended rest breaks, preferably in the event of fatigue detectable by the occupant position monitoring system.

1.-13. (canceled)

14. A safety apparatus for a motor vehicle, comprising:
a plurality of occupant protection elements;
a plurality of sensors associated with the plurality of occupant protection elements;
a processing device that checks whether at least one of the occupant protection elements and the associated sensors are at least one of in operation and properly functional, the processing device ascertaining status information from at least one of the occupant protection elements and the associated sensors; and
an output device that, in consideration of the status information, communicates an operating status possessed by at least one of each individual occupant protection element and each sensor.

15. The apparatus as defined in claim 14, further comprising:
at least one further sensor that senses a seating position of at least one occupant, wherein:
the processing device takes a sensed signal from the at least one further sensor into account in ascertaining the status information.

16. The apparatus as defined in claim 14, wherein:
the processing device includes a calculation device that, from the status information, calculates an individual occupant safety level for at least one of a driver and a passenger and outputs the individual occupant safety level via the output device.

17. The apparatus as defined in claim 14, wherein:
the output device includes at least one of:
at least one of a driver display, a separate passenger display, and a central display having separate indicators for driver and passenger for optical communications,
a windshield protection device for optical communications,
a voice output device for acoustic communications,
a warning tone device for acoustic communications, and
at least one of an electrically displaceable seat and a reversible belt tensioner for haptic communications.

18. The apparatus as defined in claim 14, further comprising:
a central data transmission device to which the processing device is connected and that makes further current vehicle data available to the processing device for inclusion.

19. The apparatus as defined in claim 18, wherein:
the current vehicle data is coupled via the central data transmission device into at least one of a filtering device and an extraction device of the processing device, and
the current vehicle data encompass data from at least one of an ABS system and an ESP system.

20. The apparatus as defined in claim 14, further comprising at least one of:
a monitoring device for monitoring at least one of a driver airbag and a passenger airbag;
a pre-crash sensor device; and
an emergency seat displacement device.

21. The apparatus as defined in claim 20, wherein:
the processing device includes at least one of a filtering device and an extraction device,
the at least one of the filtering device and the extraction device filters a signal of the monitoring devices and is connected to a GPS device that supplies vehicle position data for inclusion.

22. The apparatus as defined in claim 18, wherein the processing device includes an output for outputting data to the central data transmission device.

23. The apparatus as defined in claim 14, wherein the processing device includes a storage device for providing a nonvolatile storage of at least one of processed data and status information.

24. A method for communicating a status of a safety apparatus of a motor vehicle, comprising:
checking whether at least one of a plurality of occupant protection elements and an associated plurality of sensors are at least one of in operation and properly functional;
ascertaining status information from the at least one of the plurality of occupant protection elements and the associated plurality of sensors; and
outputting, in consideration of the status information, an operating status possessed by at least one of each individual occupant protection element and each sensor.

25. The method as defined in claim 24, further comprising:
evaluating the status information in the processing device; and
ascertaining in and communicating to at least one occupant from the processing device an occupant safety level at least one of before driving and while driving.

26. The method as defined in claim 24, wherein for each individual occupant, an occupant protection level specified for him is ascertained and outputted.

27. The apparatus as recited in claim 14, wherein the at least one occupant includes at least one of a driver and a passenger.

28. The apparatus as recited in claim 18, wherein the central data transmission device includes a CAN bus.
